(19) United States
(12) Patent Application Publication
(10) Pub. No.: US 2011/0150058 A1
(43) Pub. Date: Jun. 23, 2011

(54) CABLE MODEM CONTROL METHOD BASED ON CHANNEL STATES

(75) Inventor: Hye Ju Oh, Daejeon (KR)

(73) Assignee: Electronics and Telecommunications Research Institute, Daejeon (KR)

(21) Appl. No.: 12/886,989

(22) Filed: Sep. 21, 2010

(30) Foreign Application Priority Data
Dec. 18, 2009 (KR) 10-2009-0127260

(51) Int. Cl. H04L 5/16; H04B 17/00

(52) U.S. Cl. 375/222; 375/224

(57) ABSTRACT

Provided is a cable modem control method. The cable modem control method checks upstream parameters which are received by a cable modem termination system to check a status of an upstream channel. The cable modem control method determines whether the upstream channel is good or whether to allow an upstream data transmission of a cable modem on the basis of a result of the check. The cable modem control method suspends the upstream data transmission of the cable modem and performs ranging when the upstream channel is not good as a result of the determination. The cable modem control method postpones bandwidth allocation to a channel of the cable modem and allocates a bandwidth to another usable upstream channel. The cable modem control method returns to a normal status when the ranging is successfully ended.

### CROSS-REFERENCE TO RELATED APPLICATIONS

This U.S. non-provisional patent application claims priority under 35 U.S.C. §119 of Korean Patent Application No. 10-2009-0127260, filed on Dec. 18, 2009, the entire contents of which are hereby incorporated by reference.

### BACKGROUND OF THE INVENTION

The present invention disclosed herein relates to a method for controlling data transmission in digital cable broadcasting, and more particularly, to a method for controlling the upstream data transmission of a cable modem according to the upstream channel statuses of the cable modem.

Cable Television (CATV), as a scheme that distributes the public broadcasting of a broadcasting station to all subscribers over a cable through master antenna facilities in an area where public reception is poor, was started as a community antenna television system having a function of solving a fringe area (where reception is poor) in America in 1949. Afterward, the CATV has been introduced into all over the world as a cable broadcasting system that denotes TV broadcasting with cables, in response to public TV broadcasting together with the penetration of TV broadcasting. Such a CATV has been evolved from a coaxial cable into a Hybrid Fiber Coaxial cable (HFC).

FIG. 1 is a diagram schematically illustrating a Cable Modem Termination System (CMTS) and Cable Modem (CM) of an HFC which may transmit data over a plurality of transmission/reception channels.

Referring to FIG. 1, a CMTS 101 and a plurality of cable modems 107 may simultaneously transmit and/or receive data over a plurality of channels DC1 to DC5 and UC1 to UC5 on an HFC 106. Respective cable modems 107 (which are indicated as CM1 to CM3) may be connected to multimedia devices such as Personal Computers (PCs) and Set-Top Boxes (STBs) and provide video, audio and data services.

The CMTS 101 may be divided into a PHY module 103 that operates a physical layer for data transmission/reception and a Media Access Control (MAC) module 102 that operates DOCSIS MAC framing. The PHY module 103 includes a plurality of downstream PHY transmission units 104 that transmit downstream data, and a plurality of upstream PHY transmission units 105 that receive upstream data. In the PHY module 103 and the MAC module 102, when downstream, a Downstream External PHY Interface (DEPI) protocol 108 is used, and when upstream, a DOCSIS MAC-PHY Interface (DMPI) protocol is used.

For the CMTS 101 and the cable modem 107 transmitting/receiving data, generally, a frequency and a power value should be identical, and transmission timing and an equalizer coefficient should be adjusted. When transmission timing is not adjusted, a received power is low, a frequency is different or an equalizer coefficient is not adjusted, accurate data transmission/reception may be made by correcting an offset value through ranging.

For this, the CMTS 101 allows the cable modem 107 to periodically perform ranging. However, even in a case irrelevant to ranging, channel statuses may become worse, and in this state, a probability that an error of transmitted data occurs may become higher because a data receiving status is not good in the CMTS 101. In the existing ranging operation, data may be continuously transmitted over an upstream channel during a section (i.e., a section before a ranging operation is completed) where ranging is performed. Accordingly, it is difficult to guarantee accuracy for data that is transmitted over an upstream channel while ranging is being performed.

### SUMMARY OF THE INVENTION

The present invention provides a cable modem control method, which can prevent an error from occurring in data that is transmitted over an upstream channel when a channel status is not good or during a section where ranging is performed, and can transmit accurate data.

Embodiments of the present invention provide a cable modem control method including: checking upstream parameters which are received by a cable modem termination system to check a status of an upstream channel; determining whether the upstream channel is good or whether to allow an upstream data transmission of a cable modem on the basis of a result of the check; pausing the upstream data transmission of the cable modem and performing ranging when the upstream channel is not good as a result of the determination; postponing bandwidth allocation to a channel of the cable modem and allocating a bandwidth to another usable upstream channel; and returning to a normal status when the ranging is successfully ended.

In some embodiments, the checking of a status of an upstream channel may be performed when upstream data is received from the cable modem.

In other embodiments, the upstream parameters may include a frequency, a power, an equalizer status and timing when a burst data is received from the cable modem.

In still other embodiments, values of the upstream parameters may be within a transmission allowable range.

In even other embodiments, the cable modem termination system may be set to receive the upstream parameters each time a burst is received or when a ranging-requesting message is received.

In yet other embodiments, the cable modem control method may further include: pausing transmission of the upstream data, and performing ranging; transmitting a cable control request message, which is set to suspend transmission of the upstream data, from the cable modem termination system to the cable modem; receiving, by the cable modem termination system, a response signal to the cable control request message from the cable modem; pausing, by the cable modem termination system, bandwidth allocation except an Interval Usage Code (IUC) 4 to the cable modem when the response signal is received; and performing, by the cable modem, the ranging to include the upstream parameters within a normal range.

In further embodiments, the cable control request message may include TLV encoding information for pausing the upstream data transmission of the cable modem or releasing a transmission suspension of the upstream data of the cable modem according to a data value which is set.

In still further embodiments, the cable control request message may include an upstream channel ID which is determined not to be good.

In even further embodiments, the cable modem may suspend the transmission of the upstream data or release a transmission suspension of the upstream data in response to the cable control request message regardless of whether the ranging is completed.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a diagram schematically illustrating a Cable Modem Termination System (CMTS) and Cable Modem (CM) of an HFC which may transmit data over a plurality of transmission/reception channels;

FIG. 2 is a diagram schematically illustrating the upstream channel PHY status information characteristic of a CMTS according to an embodiment of the present invention;

FIG. 3 is a diagram illustrating the exemplary configuration of a CM-CTRL-REQ message which is used for a CMTS to temporarily suspend the data transmission of a cable modem;

FIG. 4 is a flowchart exemplarily illustrating a cable modem control method based on channel statuses according to an embodiment of the present invention; and

FIG. 5 is a flowchart exemplarily illustrating a ranging operation using a CM-CTRL-REQ message according to an embodiment of the present invention.

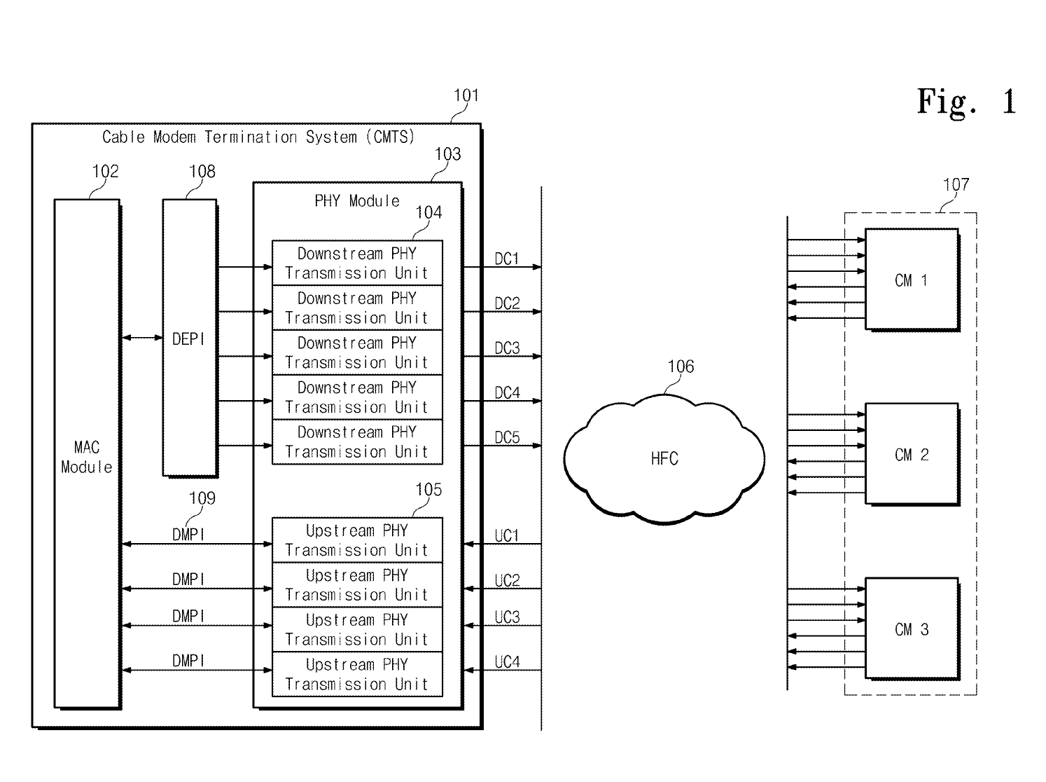

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Like reference numerals refer to like elements throughout. Similar reference numerals refer to similar elements throughout. The invention may be embodied in many different forms and should not be construed as being limited to the embodiments set forth herein.

The present invention relates to an upstream channel control method for a cable modem of a CMTS in an HFC using a plurality of transmission/reception channels. The CMTS frequently checks the channel statuses of the cable modem, and prevents an error from occurring in data that is transmitted when a channel status is not good or while ranging is being performed. For this, a cable modem control method according to embodiments of the present invention that is performed in the CMTS may include: checking upstream channel states; checking the statuses of the cable modem to determine whether to allow data transmission other than ranging; temporarily pausing the transmission of upstream data when the channel status of the cable modem is bad and performing ranging; postponing bandwidth allocation for a corresponding channel of the cable modem and allocating a bandwidth to another usable upstream channel while ranging is being performed; and returning to a normal status for receiving upstream data when ranging is successfully ended.

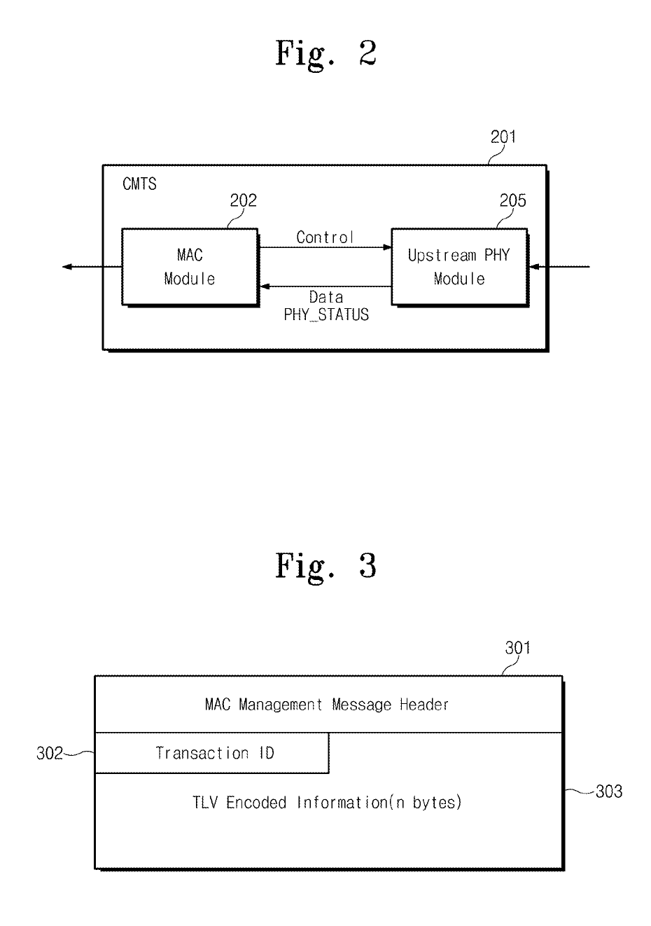

FIG. 2 is a diagram schematically illustrating the upstream channel PHY status information characteristic of a CMTS 201 according to an embodiment of the present invention.

In an exemplary embodiment of the present invention, a CMTS 201 according to an embodiment of the present invention may support the DOCSIS 3.0 standard. The CMTS 201 may conform to the DOCSIS MAC-PHY Interface protocol between a MAC module 202 and an upstream PHY module 205 for receiving upstream data.

Referring to FIG. 2, the upstream PHY module 205 receives burst data from a cable modem to divide the burst data into data blocks and transfers the divided data to the MAC module 202. The MAC module 202 of the CMTS 201 may set whether to receive PHY status information each time a burst is received or only when a ranging-requesting message is received, in a register of the PHY module 205 for checking the upstream channel status of the cable modem. The MAC module 202 may access the PHY module 205 through a control signal Control, and the PHY module 205 may transfer the received burst Data and PHY status information PHY_STATUS to the MAC module 202 in response to the control signal Control.

As a result, by checking upstream parameters (for example, PHY status information PHY_STATUS) that are received by the CMTS 201, the CMTS 201 may frequently check the upstream channel statuses of the cable modem. The CMTS 201 determines whether a corresponding upstream channel is good and whether to allow the upstream data transmission of the cable modem with the checked upstream channel states. Although described below, the CMTS 201 suspends the upstream data transmission of the cable modem and performs control in order for ranging to be performed when the upstream channel is not good. The CMTS 201 postpones bandwidth allocation for the channel of the cable modem and allocates a bandwidth to another usable upstream channel while ranging is being performed, and thereafter when ranging is successfully ended, the CMTS 201 returns to a normal state.

The detailed configuration of the format and type of the data block, which has been processed by the upstream PHY module 205, is as follows.

Table 1 shows the format of the data block that has been processed by the upstream PHY module 205. The MAC module 202 receives upstream data, having the format of the data block that is shown in the Table 1, from the PHY module 205.

TABLE 1

| Size (byte) | Name | Description |
|---|---|---|
| 1 | Block Type | Data Block Type |
| 2 | Block Length | Byte Length of Data Block |
| N | Block Data | Data of Data Block |

Table 2 shows the detailed configuration of the data block type that is shown in the Table 1.

TABLE 2

| Type | Name | Description |
|---|---|---|
| 0 | Reserved | Reserved |
| 1 | FIRST DATA | First Data of Burst |
| 2 | MIDDLE DATA | Middle Data of Burst |
| 3 | LAST DATA | Last Data of Burst |
| 4 | PHY_STATUS | PHY Status Information |
| 5 | NO_BURST | No Burst During Transmission Section |
| 6 | CHANNEL | Channel over which a next data block is |
| | | transmitted |
| | Reserved | Reserved |

Referring to Table 2, the PHY module 205 may divide a received burst into a first data FIRST_DATA, a middle data MIDDLE_DATA and a last data LAST_DATA and transmit them. The PHY module 205 transmits upstream data in a data block type having information such as PHY status information PHY_STATUS, no burst information NO_BURST and a channel information CHANNEL over which a next data block is to be transmitted.

When the PHY module 205 of the CMTS 201 receives upstream data from the cable modem, the PHY module 205 may inform the MAC module 202 of a data block (refer to Data in FIG. 2) and PHY status information such as the type 4 in the Table 2 (refer to PHY_STATUS in FIG. 2). According to such a configuration, the CMTS 201 may frequently check and manage upstream channel information on the basis of the PHY status information PHY_STATUS. When a channel status is not good in consideration of the channel state, the CMTS 201 controls the operation of the cable modem in order to temporarily suspend the transmission of all upstream data irrelevant to the ranging of the cable modem and to perform ranging.

FIG. 3 is a diagram illustrating the exemplary configuration of a cable control request message CM-CTRL-REQ which is used for the CMTS 201 to temporarily suspend the data transmission of the cable modem.

A CM-CTRL-REQ message is one that is transmitted by the CMTS 202 in order for the cable modem to perform a specific type of operation.

Referring to FIG. 3, the CM-CTRL-REQ message may be configured with a MAC management message header 301, a transaction identification (ID) 302 and TLV encoding information 303. The transaction ID 302 and the TLV encoding information 303 may be arranged after the MAC management message header 301. The TLV encoding information 303 may include information corresponding to a type code for controlling the cable modem.

Table 3 shows the detailed configuration of the TLV encoding information 303 in FIG. 3.

TABLE 3

| Type | Length | Value |
|---|---|---|
| 1 | 1 | Upstream Channel RF Mute. Upstream Channel ID |
| 2 | 4 | RF Mute Timeout Interval |
| 3 | 1 | CM Reinitialize |
| 4 | 1 | Disable Forsarding |
| 5 | 7 | Override for the Downstream Status Event Enable |
| | | Bitmask |
| 5.1 | 1 | Downstream Channel ID |
| 5.2 | 2 | Downstream Status Event Enable Bitmask |
| 6 | 7 | Override for the Upstream Status Event Enable |
| | | Bitmask |
| 6.1 | 1 | Upstream Channel ID |
| 6.2 | 2 | Upstream Status Event Enable Bitmask |
| 7 | 2 | Override for the CM-STATUS Event Enable |
| | | Bitmask for Non-Channel-Specific Event |
| 8 | 1 | Suspend Transmission of everything except RNG- |
| | | REQ (1: Suspend, 0: Dissolve) |
| 8.1 | 1 | Upstream Channel ID |

Referring to the Table 3 and FIG. 3, the CMTS 201 may suspend the Radio Frequency (RF) operation of an upstream channel in a physical layer transmission level for a certain time (where a MAC layer status is not changed), restart the cable modem, control Protocol Data Units (PDU) forwarding, or enable/disable a specific event of an upstream/downstream channel, with the CM-CTRL-REQ message.

In addition, in an embodiment of the present invention, as shown in the Table 3, by adding the type 8 to the existing TLV (for example, the type 1 to type 7), the CMTS 201 may temporarily suspend data transmission for the upstream channel of the cable modem. The CMTS 201 checks the upstream channel status of the cable modem on the basis of the PHY status information PHY_STATUS, and when the checked result shows that the channel status is sufficiently unfavorable for transmitting data, the CMTS 201 includes a corresponding upstream channel ID “Upstream Channel ID” in the type 8 of the CM-CTRL-REQ message (see the type 8.1 of the Table 3) and transmits the CM-CTRL-REQ message to the cable modem. In an exemplary embodiment of the present invention, it may be defined that the CMTS 201 disallows the cable modem to transmit a message except an RNG-REQ message when the value of the type 8 of the CM-CTRL-REQ message is 1 and releases the disallowing of message transmission when the value of the type 8 of the cable control request message CM-CTRL-REQ is 0. As shown in the type 8.1 of the Table 3, an upstream channel ID may be included as a sub-TLV. When the CM-CTRL-REQ message is received, the cable modem sends a CM-CTRL-RSP message in response to the CM-CTRL-REQ message.

In an embodiment of the present invention, the CM-CTRL-REQ message of the type 8 may be used when the upstream channel status of the cable modem is not good, may be used when pausing data transmission for preferentially allocating an upstream channel bandwidth to another cable modem, or may be used for giving packet load balance because a too large amount of traffic occurs. This is not limited to a specific embodiment, and the CM-CTRL-REQ message of the type 8 may be used at any time for controlling the upstream data transmission of the cable modem according to an operator's requirement.

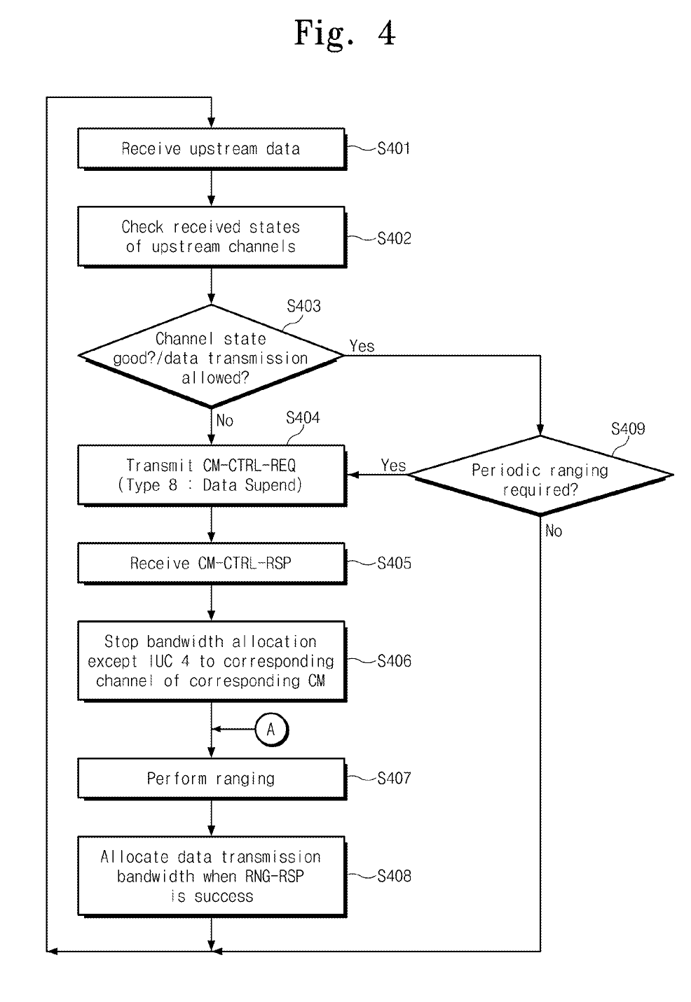

FIG. 4 is a flowchart exemplarily illustrating a cable modem control method based on channel statuses according to an embodiment of the present invention.

Referring to FIG. 4, the CMTS 201 receives burst data from a cable modem over an upstream channel in operation S401. Whenever the burst data is received, the CMTS 201 checks the upstream channel status of the cable modem in operation S402. The check operation of the upstream channel state, which is performed in operation S402, may be performed by checking upstream parameters (for example, PHY status information PHY_STATUS) received. At this point, the check of the channel statuses may denote whether parameter values, which are associated with transmission such as a frequency, a power, an equalizer status and timing when the burst data is received, are included within a transmission allowable range.

Based on the checked result of the upstream channel status that has been performed in operation S402, the CMTS 201 determines whether the channel status is good or whether to allow data transmission over an upstream channel of a corresponding cable modem in operation S403. When the determined result of operation S403 shows that the channel status is not good or when intending to suspend the transmission of data except an RNG-REQ message over a corresponding upstream channel of a corresponding cable modem because the channel status is bad, the flow proceeds to operation S404. The CMTS 201 transmits a CM-CTRL-REQ message including the type 8 of the Table 3 in operation S404.

Subsequently, the CMTS 201 receives a CM-CTRL-RSP message as a response message from a cable modem in operation S405, and suspends the allocation of a bandwidth except an Interval Usage Code (IUC) 4 to a corresponding channel of a corresponding cable modem in operation S406. In this case, when another usable upstream channel exists, the CMTS 201 allows channel allocation to be performed to the channel. Then, the CMTS 201 performs ranging and thereby allows all parameters to be within a normal range in operation S407. When ranging is successfully completed, the CMTS 201 allocates a data transmission bandwidth in operation S408, an operation returns to operation S401, and the CMTS 201 receives upstream data.

When the determined result of operation S403 shows that the channel status is good by the degree where data may be transmitted or when allowing the transmission of data except an RNG-REQ message over a corresponding upstream channel of a corresponding cable modem, whether to require periodic ranging is determined in operation S409.

When periodic ranging is required as the determined result of operation S409, the flow proceeds to operation S404 and performs ranging when a periodic ranging time arrives after waiting. In this case, the CMTS 201 transmits the CM-CTRL-REQ message including the type 8 of the Table 3, for performing a ranging operation in operation S404.

When periodic ranging is not required as the determined result of operation S409, an operation returns to operation S401 and receives upstream data.

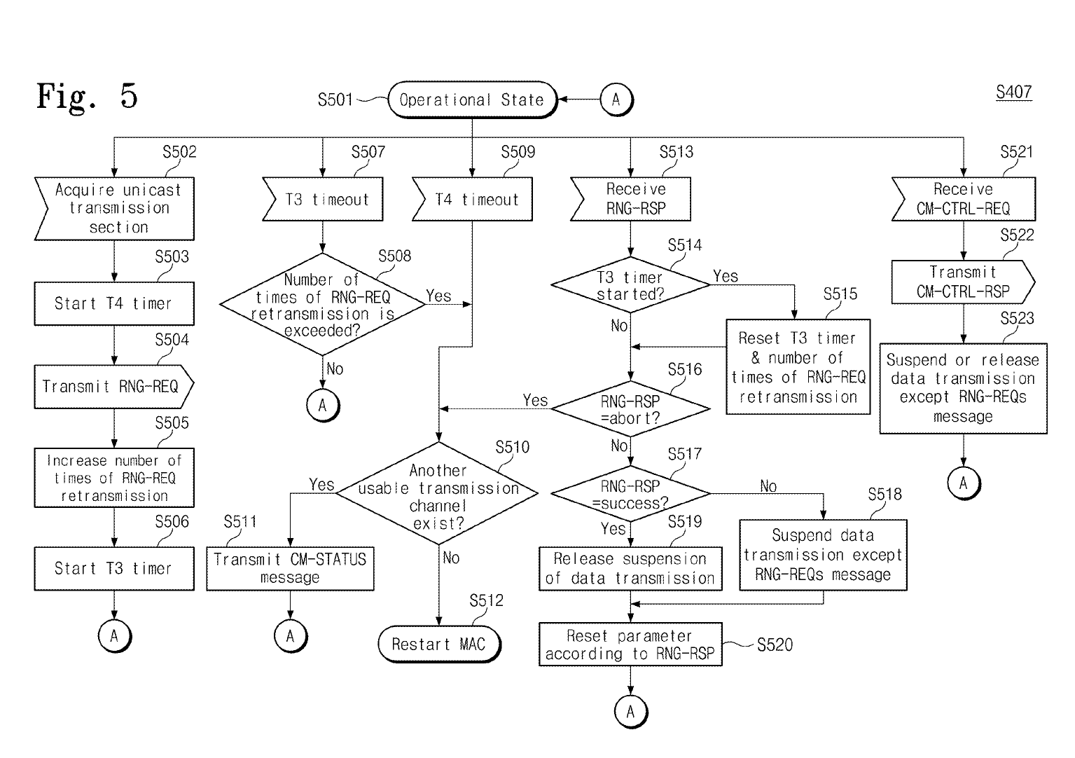

FIG. 5 is a flowchart exemplarily illustrating a ranging operation using a CM-CTRL-REQ message according to an embodiment of the present invention. In FIG. 5, a detailed flowchart of the ranging operation (operation S407) in FIG. 4 is illustrated.

Referring to FIG. 5, the CMTS 201 performs bandwidth allocation for requesting ranging to a cable modem before a time T4 arrives at the longest (i.e., wait for unicast ranging opportunity). The cable modem acquires a unicast transmission section through an MAP message in operation S502, and starts a T4 timer for next ranging in operation S504. The cable modem transmits an RNG-REQ message in an allocated section in operation S504. The cable modem transmits the RNG-REQ message and then increases the number of times the RNG-REQ message is transmitted in operation S505. The cable modem starts a T3 timer (i.e., wait for ranging response) and returns to an operational state.

When T3 timeout occurs in the operational status in operation S507, this denotes that the cable modem has not received an RNG-RSP message for a time T3, and thus the flow proceeds to operation S508. The cable modem checks the number of times the RNG-REQ message is retransmitted in operation S508, and determines whether the number of times the RNG-REQ message is retransmitted exceeds a certain number of retransmission times (for example, sixteen times) in operation S508. When the determined result of operation S508 shows that the number of times the RNG-REQ message is retransmitted does not exceed a certain number of retransmission times, an operation returns to the operational state. When the determined result of operation S508 shows that the number of times the RNG-REQ message is retransmitted exceeds a certain number of retransmission times, this denotes there is a limitation in the use of a channel, and thus the cable modem checks whether another usable channel exists in operation S510. When another usable channel exists as the checked result of operation S510, the cable modem informs the existence of the other usable channel by sending a CM-STATUS message to the CMTS 201, and waits the response of the CMTS 201 in operation S511. When another usable channel does not exist as the checked result of operation S510, the cable modem restarts MAC in operation S512.

When T4 timeout occurs in the operational status in operation S509, this denotes that periodic ranging is not performed within a corresponding period. Thus, the flow proceeds to operation S510, and the cable modem checks whether another usable channel exists in operation S510. When another usable channel exists as the checked result of operation S510, the cable modem informs the existence of the other usable channel by sending a CM-STATUS message to the CMTS 201, and waits the response of the CMTS 201 in operation S511. When another usable channel does not exist as the checked result of operation S510, the cable modem again starts from an initialization stage by restarting MAC in operation S512.

When the cable modem sends an RNG-REQ message and then receives an RNG-RSP message in operation S513, it determines whether a T3 timer that is being operated exists in operation S514. When the T3 timer that is being operated exists as the determined result of operation S514, the cable modem resets the number of times the RNG-REQ message is retransmitted and the T3 timer in operation S515. Subsequently, the cable modem checks the RNG-RSP message to determine whether a ranging is aborted in operation S516. When the RNG-RSP message indicates the abort of the ranging as the determined result of operation S516, the flow proceeds to operation S510 and checks another usable channel. Then, the cable modem performs a MAC restart operation according to the presence of a usable channel or transmits a CM-STATUS message to the CMTS 201. When the RNG-RSP message indicates the non-abort of the ranging as the determined result of operation S516, the flow proceeds to operation S517 and determines whether the ranging succeeds.

When the ranging does not succeed (i.e., a ranging is continued) as the determined result of operation S517, the cable modem suspends the transmission of data except the RNG-REQ message in operation S518, and resets a parameter according to the setting of the message RNG-RSP in operation S520. Subsequently, an operation returns to the operational status and waits an RNG-REQ message transmission section. When the ranging succeeds as the determined result of operation S517, the cable modem releases a transmission suspension of data except the RNG-REQ message in operation S519 and resets a parameter according to the setting of the RNG-RSP message in operation S520. Then, an operation returns to the operational status and waits a next RNG-REQ message transmission section.

In the operational state, the CM-CTRL-REQ message of the type 8 is received from the CMTS 201 to the cable modem in operation S521, and when the CM-CTRL-REQ message has a value of 1, the cable modem immediately transmits the CM-CTRL-REQ message to the CMTS 201 in operation S522. The cable modem suspends the transmission of upstream data except the RNG-REQ message for a corresponding upstream channel in operation S523. At this point, when the CM-CTRL-REQ message of the type 8 that is received from the CMTS 201 to the cable modem has a value of 0, the cable modem transmits a response message CM-CTRL-RSP and releases the transmission suspension of upstream data that was made before. Then, an operation returns to the operational state, and the cable modem waits a unicast transmission section for a ranging request from the CMTS 201.

As described above, the cable modem control method according to embodiments of the present invention may largely include: checking upstream channel states; checking the statuses of the cable modem to determine whether to allow data transmission other than ranging; temporarily pausing the transmission of upstream data when the channel status of the cable modem is bad and performing ranging; postponing bandwidth allocation for a corresponding channel of the cable modem and allocating a bandwidth to another usable upstream channel while ranging is being performed; and returning to a normal status when ranging is successfully ended. According to such a configuration, the CMTS can frequently check the channel statuses of the cable modem and prevent an error from occurring in data that is transmitted when a channel status is not good or while ranging is being performed. As a result, the accuracy of the upstream data transmission of the cable modem increases, and the CMTS checks and manages the channel statuses of the cable modem and thus can flexibly operate and maintain the upstream channel.

According to the above-described embodiments of the present invention, the CMTS can frequently check and manage upstream channel information with data that is received from the cable modem on the HFC. Furthermore, when a channel status is not good, the CMTS can temporarily suspend the transmission of all upstream data irrelevant to the ranging of the cable modem and perform ranging.

As a result, the cable modem control method according to embodiments of the present invention prevents an error from occurring in data that is transmitted when a channel status is not good or while ranging is being performed, thereby increasing the accuracy of the upstream data transmission of the cable modem. Moreover, the CMTS checks and manages the channel statuses of the cable modem and thus can flexibly operate and maintain the upstream channel.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A cable modem control method, comprising:
checking upstream parameters which are received by a cable modem termination system to check a status of an upstream channel;
determining whether the upstream channel is good or whether to allow an upstream data transmission of a cable modem on the basis of a result of the check;
pausing the upstream data transmission of the cable modem and performing ranging when the upstream channel is not good as a result of the determination;
postponing bandwidth allocation to a channel of the cable modem and allocating a bandwidth to another usable upstream channel; and
returning to a normal status when the ranging is successfully ended.

2. The cable modem control method of claim 1, wherein the checking of a status of an upstream channel is performed when upstream data is received from the cable modem.

3. The cable modem control method of claim 1, wherein the upstream parameters comprises a frequency, a power, an equalizer status and timing when a burst data is received from the cable modem.

4. The cable modem control method of claim 1, wherein in the checking of a status of an upstream channel, values of the upstream parameters are within a transmission allowable range.

5. The cable modem control method of claim 1, wherein the cable modem termination system is set to receive the upstream parameters each time a burst is received or when a ranging-requesting message is received.

6. The cable modem control method of claim 1, further comprising:
pausing transmission of the upstream data, and performing ranging;
transmitting a cable control request message, which is set to suspend transmission of the upstream data, from the cable modem termination system to the cable modem;
receiving, by the cable modem termination system, a response signal to the cable control request message from the cable modem;
pausing, by the cable modem termination system, bandwidth allocation except an Interval Usage Code (IUC) 4 to the cable modem when the response signal is received; and
performing, by the cable modem, the ranging to comprise the upstream parameters within a normal range.

7. The cable modem control method of claim 6, wherein the cable control request message comprises TLV encoding information for pausing the upstream data transmission of the cable modem or releasing a transmission suspension of the upstream data of the cable modem according to a data value which is set.

8. The cable modem control method of claim 6, wherein the cable control request message comprises an upstream channel ID which is determined not to be good.

9. The cable modem control method of claim 6, wherein the cable modem suspends the transmission of the upstream data or releases a transmission suspension of the upstream data in response to the cable control request message regardless of whether the ranging is completed.
